(19) United States
(12) Patent Application Publication
(10) Pub. No.: US 2004/0192143 A1
(43) Pub. Date: Sep. 30, 2004

(54) Accumulated layer of structure fabric mixed with far infrared ray ceramic powder and resin

(76) Inventor: Cheng-Lin Chuang, Taichung City (TW)

Correspondence Address: BACON & THOMAS, PLLC, 625 SLATERS LANE, FOURTH FLOOR, ALEXANDRIA, VA, 22314

(21) Appl. No.: 10/396,836

(22) Filed: Mar. 26, 2003

(51) Int. Cl. D04H 1/00; D04H 3/00; D04H 5/00; D04H 13/00; B32B 15/14; B32B 5/26; B32B 27/12; B32B 5/16

(52) U.S. Cl. 442/381; 442/394; 442/417

(57) ABSTRACT

The present invention relates to the accumulated layer of structure fabric mixed with far infrared ray ceramic powder and resin comprising the upper layer is knitting fabric, plain woven fabric, non-woven fabric or TPU film, TPE film, especially the middle layer is formed by mixing different ratios of far infrared ray ceramic powder and wetting reactive resin and the lower layer is made of various kinds of fabrics processed by spraying on the surface of lower layer and sticking with the upper layer and the middle layer is made of far infrared ray ceramic powder mixed with resin layer, which has functions such as accelerating the blood circulation, saving heat and keeping body warm, and anti-mildew, especially when wearing it in winter has effects of saving heat and keeping body warm. Besides, the whole fabric has functions of keeping body warm. This invention can be used in outdoors clothing, hats, masks, gloves, shoe-pads, underwear such as brassiere, filtering materials, protecting clothes and socks.

### FIELD OF THE INVENTION

The present invention relates to an accumulated layer of structure fabric mixed with far infrared ray ceramic powder and resin, especially to the application of far infrared ray ceramic powder mixed resin layer in the fabric.

### BACKGROUND OF THE INVENTION

The general way to make far infrared ray ceramic powder layer fabric is after mixing far infrared ray ceramic powder and PP, PE, and PP, reel off to make fiber and then form into fabrics. Another way is to mix far infrared ray ceramic powder and resin, using the way of dipping and dyeing non-woven fabric or coating to be proceed sticking with the other side. As shown in FIG. 1, its main process is to set dipping layer b on basic layer c. It is obvious that will lead to the complexity of process of surface layer a, cost increasing and without any economical efficiency.

### SUMMARY OF THE INVENTION

Upon resolving the above defects, the invention applies for the patent of “Accumulated layer of structure fabric mixed with far infrared ray ceramic powder and resin”. Its upper layer is made of the plain woven layer, non-woven fabric or TPU film, TPE film, and PP film; middle layer is made of far infrared ray ceramic powder and wetting reactive resin mixed layer; the lower layer is made of knitting fabric, non-woven fabric and plain woven fabric. Therefore, the invention is three layers finished in one time. The main features of the invention are to be done easily and simply as well as to achieve the functions of accelerating blood circulation, saving heat and keep things warm and anti-mildew, etc. The features and functions of the purposes of the invention can be described by the following better practical examples in accommodation with drawings and figures as follows:

### BRIEF DESCRIPTION OF THE DRAWING

FIG. 1 shows the prior art is accumulated layer of structure fabric in the sectional drawing

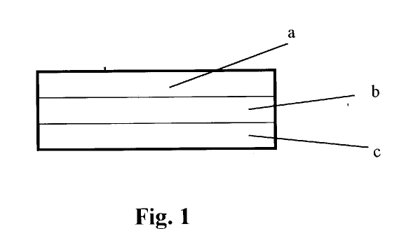

FIG. 2 shows the making process of the accumulated layer of structure fabric mixed with far infrared ray ceramic powder and resin layer of the invention.

FIG. 3 shows the sectional drawing of the accumulated layer of structure fabric mixed with far infrared ray ceramic powder and resin layer of the invention.

### DETAILED DESCRIPTION OF THE PREFERRED EMBODIMENTS

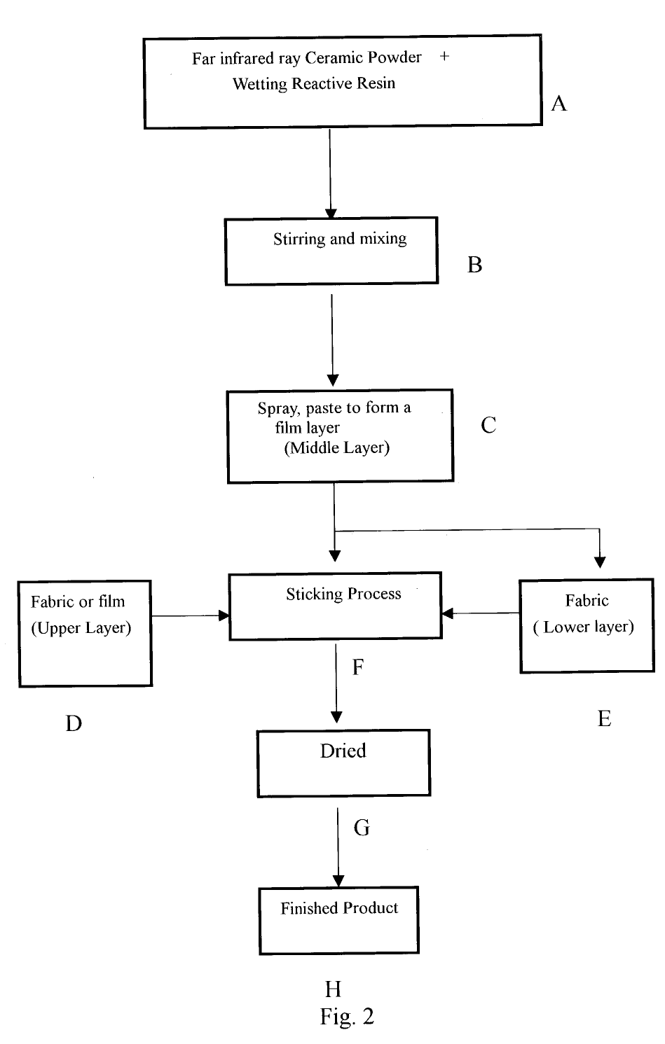

The invention is the accumulated layer of structure fabric mixed with far infrared ray ceramic powder and resin. FIG. 2 shows the making process of the accumulated layer of structure fabric mixed with far infrared ray ceramic powder and resin of the invention. First, mix and stir different weight ratio of far infrared ray ceramic powder with wetting reactive resin A,B,which uses 10˜99% weight percentage of wetting reactive resin to mix with 0.3˜10% weight percentage of far infrared ray ceramic powder and stirred in way of gluing. The wavelength of far infrared ray ceramic powder is 4˜14 um and its main components are zirconium oxide and wheat-rice stone and ground into 0.1 m/m powder of nanometer scale and mixed, sprayed and pasted with reactive resin to form a coating layer (middle layer) C; and paste in a coating quantity of 20˜100 g/m² on the basic layer (fabric)E, and then proceed sticking F in the speed of 5˜30 yd/min and sticking temperature (40˜120° C.) with the fabric or sticking of the upper layer D, and dried G to form a finished product H.

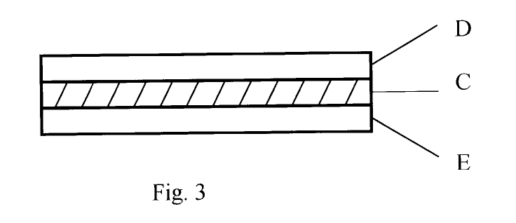

FIG. 3 shows the middle layer C formed on the fabric layer E and as the sticking process of the fabric layer or resin coating layer D to form a finished product.

One can learn from above that the invention mixes the far infrared ray powder with wetting reactive resin to make the middle layer of the accumulated layer fabric with far infrared ray ceramic powder and mixed resin layer sprayed onto the lower layer of the layer composition, and then uses the fabric or film of the upper layer as three layer composition processed at one time. Obviously, the process has become very easy and simple and can achieve the functions of accelerating the blood circulation, saving heat and keep things warm, and anti-mildew. Beside it has effect of keeping things warm.

What is claim is:

1. A accumulated layer of structure fabric mixed with infrared ray ceramic powder and resin comprising the upper layer is fabric layer or film layer and the lower layer is non-woven fabric layer or fabric layer; the characteristic is its the middle layer which is formed by mixing 0.3˜10% weight percentage of Far infrared ray ceramic powder and 10˜99% weight percentage of wetting reactive resin to form Far infrared ray ceramic powder mixed with resin layer, and proceed surface spraying and coating with coating quantity of 5˜200 g/m² and proceed the sticking with the upper layer and then being dried to be done as finished, which has functions such as accelerating the blood circulation, saving heat and keeping body warm, and anti-mildew, antiseptic, lower layer use TPU film. TPE film and PP film of sticking of the waterproof and penetrated wet, especially when wearing it in winter has effects of saving heat and keeping body warm. Besides, the whole fabric has functions of keeping body warm. This invention can be used in outdoors clothing, hats, masks, gloves, shoe-pads, underwear such as brassiere, filtering materials, protecting clothes and socks.

2. A accumulated layer of structure fabric mixed with infrared ray ceramic powder and resin as defined in claim 1, wherein a far infrared ray ceramic powder is made of zirconium oxide, zinc oxide, and wheat-rice stone.

3. A accumulated layer of structure fabric mixed with infrared ray ceramic powder and resin as defined in claim l,wherein the size of far infrared ray ceramic powder is from 10⁻⁹ m to 0.1 m/m.

4. A accumulated layer of structure fabric mixed with infrared ray ceramic powder and resin as defined in claim 1,wherein the upper layer is TPU film PP film and TPE film.
